(19) United States
(12) Patent Application Publication
(10) Pub. No.: US 2020/0285254 A1
(43) Pub. Date: Sep. 10, 2020

(54) OBSTACLE AVOIDANCE METHOD FOR UNMANNED AERIAL VEHICLE AND UNMANNED AERIAL VEHICLE

(71) Applicant: SZ DJI TECHNOLOGY CO., LTD., Shenzhen (CN)

(72) Inventors: Junxi WANG, Shenzhen (CN); Chunming WANG, Shenzhen (CN); Xumin WU, Shenzhen (CN); Renli SHI, Shenzhen (CN)

(21) Appl. No.: 16/879,482

(22) Filed: May 20, 2020

Related U.S. Application Data
(63) Continuation of application No. PCT/CN2017/117043, filed on Dec. 18, 2017.

(51) Int. Cl. G05D 1/10; B64C 39/02; B64C 1/36; G05D 1/00; G01S 13/933

(52) U.S. Cl. CPC G05D 1/1064; B64C 39/024; B64C 1/36; B64C 2201/141; G01S 13/933; B64C 2201/027; G05D 1/0055

(57) ABSTRACT

An obstacle avoidance method for an unmanned aerial vehicle (UAV) includes determining a flight trajectory of an obstacle relative to the UAV according to measurement data output by a radar arranged at the UAV, and performing an obstacle avoidance according to the flight trajectory of the obstacle.

### CROSS-REFERENCE TO RELATED APPLICATION

This application is a continuation of International Application No. PCT/CN2017/117043, filed on Dec. 18, 2017, the entire content of which is incorporated herein by reference.

### TECHNICAL FIELD

The present disclosure relates to the technical field of flight and, more particularly, to an obstacle avoidance method for unmanned aerial vehicle (UAV) and a UAV.

### BACKGROUND

During an operation of an unmanned aerial vehicle (UAV), hills, trees and other natural objects, as well as power lines, telephone poles, buildings, and the like, in a flight corridor cause great hidden dangers to a safe flight of the UAV. In conventional technologies, binocular vision, laser and other optical lenses, as well as ultrasonic radar are used to sense the external environment of the UAV to achieve an obstacle avoidance of the UAV. However, the optical lenses are sensitive to external conditions such as light and weather conditions. In contrast, the radar is not sensitive to the external conditions, and thus, it is effective and works all day even under harsh weather such as rain, fog, dust, and the like. Therefore, the radar is also used for detecting the obstacles, and the obstacle avoidance can be realized according to the obstacles detected by the radar.

However, in conventional technologies, an obstacle misdetection is a problem for the UAV using the radar to detect obstacles.

### SUMMARY

In accordance with the disclosure, there is provided an obstacle avoidance method for an unmanned aerial vehicle (UAV) including determining a flight trajectory of an obstacle relative to the UAV according to measurement data output by a radar arranged at the UAV, and performing an obstacle avoidance according to the flight trajectory of the obstacle.

Also in accordance with the disclosure, there is provided a UAV including a rack, a radar arranged at the rack or at a load carried by the rack, and a controller arranged at the rack and communicatively coupled to the radar. The radar is configured to obtain measurement data. The controller is configured to determine a flight trajectory of an obstacle relative to the UAV according to the measurement data output by the radar, and perform an obstacle avoidance according to the flight trajectory of the obstacle.

### BRIEF DESCRIPTION OF THE DRAWINGS

In order to provide a clearer illustration of technical solutions of disclosed embodiments, the drawings used in the description of the disclosed embodiments are briefly described below. It will be appreciated that the disclosed drawings are merely examples and other drawings conceived by those having ordinary skills in the art on the basis of the described drawings without inventive efforts should fall within the scope of the present disclosure.

FIG. 1 is a schematic flow chart of an obstacle avoidance method for unmanned aerial vehicle (UAV) consistent with embodiments of the disclosure.

FIG. 2 is a schematic structural diagram of a radar consistent with embodiments of the disclosure.

FIG. 3 is a schematic flow chart of another obstacle avoidance method for UAV consistent with embodiments of the disclosure.

FIG. 4 schematically shows a relationship between echoes and a first correlation wave gate consistent with embodiments of the disclosure.

FIG. 5 schematically shows a relationship between a radar and obstacles in Cartesian coordinate system consistent with embodiments of the disclosure.

FIG. 6 is a schematic flow chart of another obstacle avoidance method for UAV consistent with embodiments of the disclosure.

FIG. 7 schematically shows generating a candidate trajectory consistent with embodiments of the disclosure.

FIG. 8 is a schematic flow chart of another obstacle avoidance method for UAV consistent with embodiments of the disclosure.

FIG. 9 schematically shows determining measurement data satisfying a preset condition consistent with embodiments of the disclosure.

FIG. 10 is a schematic structural diagram of a UAV consistent with embodiments of the disclosure.

FIG. 11 schematically shows a physical structural diagram of a UAV consistent with embodiments of the disclosure.

### DETAILED DESCRIPTION OF THE EMBODIMENTS

In order to provide a clearer illustration of technical solutions of disclosed embodiments, example embodiments will be described with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The present disclosure provides an obstacle avoidance method which can be applied to an unmanned aerial vehicle (UAV). The UAV can carry a radar configured to detect an obstacle and output measurement data corresponding to a detection of the obstacle. The measurement data may be the measurement data output by the radar after detecting the obstacle, or maybe not the real measurement data but a clutter detected by the radar, such as a ground clutter. The present disclosure can solve the problem of obstacle misdetection for the UAV using the radar to detect obstacles.

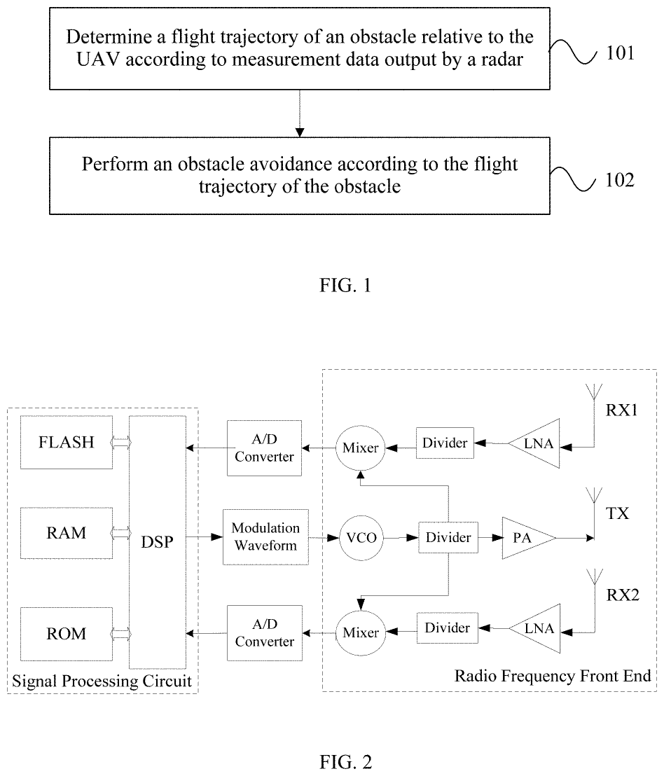

FIG. 1 is a schematic flow chart of an example obstacle avoidance method for UAV consistent with the disclosure. An execution entity of the method can include a controller of the UAV. As shown in FIG. 1, at 101, a flight trajectory of an obstacle relative to the UAV is determined according to measurement data output by a radar. The measurement data may include one or more of a speed, a distance, and an azimuth of the obstacle. In some embodiments, according to the type of antenna, the radar may include a radar having a directional antenna or a radar having a rotating antenna. When the radar having the directional antenna is adapted, the UAV can carry a plurality of radars for detecting obstacles in different directions of the UAV. For example, the UAV can carry six radars emitting radar waves toward a front direction, a lower front direction, a downward direction, a back direction, a lower back direction, and an upward direction of the UAV. If the radar having the rotating antenna is adopted, the radar can continuously rotate. The method can further include controlling the radar to continuously rotate to obtain the measurement data of the radar during a continuous rotation. For example, when the radar is continuously rotating, the radar can emit the radar waves toward the front direction, the lower front direction, the downward direction, the back direction, the lower back direction, and the upward direction of the UAV. In some embodiments, a direction of a rotation axis of the radar may be parallel to a pitch axis of the UAV.

A position where the radar is installed on the UAV can be flexibly designed according to actual needs, which is not limited herein. Emission direction of the radar waves can be flexibly designed according to actual needs, which is not limited herein.

In some embodiments, according to the detection principle of the radar, the radar can include a continuous wave radar or a pulse radar. FIG. 2 is a schematic structural diagram of an example radar consistent with the disclosure. As shown in FIG. 2, taking a frequency modulated continuous wave (FMCW) radar as an example, the radar includes a signal processing circuit and a radio frequency front end. The signal processing circuit can include a controller, e.g., a digital signal processor (DSP) or the like, and can be configured to generate a modulated signal and determine a distance from the obstacle according to a difference frequency signal captured by an analog-to-digital (A/D) converter. The signal processing circuit may further include, for example, a flash memory (FLASH), a random-access memory (RAM), a read-only memory (ROM), or the like, for storing data. The radio frequency front end can include one transmitting port and two receiving ports, i.e., one transmitting channel and two receiving channels. For the transmitting channel, a voltage-controlled oscillator (VCO) can regulate a modulation waveform generated by the signal processing circuit to generate a linear frequency modulation signal. For example, a transmitting frequency of the linear frequency modulation signal can be 24 GHz. A transmitting antenna TX can transmit the linear frequency modulation signal amplified by a power amplifier PA. The signal emitted by the transmitting antenna TX can be the radar wave. Echoes of the radar wave emitted by the transmitting antenna TX after being reflected by a target can be received by the receiving channel through receiving antennas RX1 and RX2. The target can include the obstacle. A low noise amplifier LNA can be configured to amplify the received signal. The low-noise amplified signal can be mixed (i.e., mixing the signal corresponding to the radar wave and the signal corresponding to the echo) to obtain the difference frequency signal. After the difference frequency signal is captured by the A/D convertor and inputs to the signal processing circuit, the signal processing circuit can determine the measurement data according to the difference frequency signal. Each of the receiving channels and the transmitting channel may further include a power divider (also referred to as power division). The receiving antennas RX1 and RX2 and the transmitting antenna TX may include microstrip antennas.

No matter it is a moving obstacle or a stationary obstacle, when the flying UAV is used as a reference, the obstacle always has a flight trajectory relative to the UAV. Therefore, even if the radar may output the measurement data corresponding to the clutter, because there is no obstacle corresponding to the clutter, the flight trajectory of the obstacle relative to the UAV would not be affected by the measurement data of the radar generated from the ground clutter.

The implementation manner of determining the flight trajectory of the obstacle relative to the UAV is not limited herein. For example, when a relationship between two pieces of measurement data output by two detections of the radar satisfies a preset relationship, the two pieces of measurement data can be used as two waypoints, and a route formed by the two waypoints can be determined as the flight trajectory of the obstacle relative to the UAV. The flight trajectory may include at least two waypoints, and information of each waypoint may include one or more of a position, a speed, an angle, and the like.

At 102, an obstacle avoidance is performed according to the flight trajectory of the obstacle. A flight trajectory or a flight height of the UAV can be adjusted according to the flight trajectory of the obstacle relative to the UAV to perform the obstacle avoidance. In some embodiments, a flight attitude of the UAV can be controlled according to the flight trajectory of the obstacle relative to the UAV to perform the obstacle avoidance. The flight attitude may include diving, climbing, accelerating, decelerating, rolling, and the like. The implementation manner of performing the obstacle avoidance according to the flight trajectory of the obstacle is not limited herein, and a person skilled in the art may design a corresponding obstacle avoidance strategy to avoid obstacles according to actual needs.

Consistent with the disclosure, according to the measurement data output by the radar, the flight trajectory of the obstacle relative to the UAV can be determined. The obstacle avoidance can be performed according to the flight trajectory of the obstacle. As such, even if the radar may output the measurement data corresponding to the clutter, because there is no obstacle corresponding to the clutter, the flight trajectory of the obstacle relative to the UAV would not be affected by the measurement data of the radar generated from the ground clutter. Therefore, when the obstacle avoidance is performed according to the flight trajectory of the obstacle, the obstacle avoidance based on the measurement data of the radar generated from the clutter can be avoided, and the problem of obstacle misdetection can be solved.

FIG. 3 is a schematic flow chart of another example obstacle avoidance method for UAV consistent with the disclosure. Based on the method shown in FIG. 1, the method in FIG. 3 mainly describes an example implementation manner of determining the flight trajectory of the obstacle relative to the UAV according to the measurement data output by the radar.

As shown in FIG. 3, at 301, a first predicted waypoint of the obstacle at a current moment is determined according to the flight trajectory of the obstacle relative to the UAV at a previous moment. The predicted waypoint of the obstacle at the current moment, i.e., the first predicted waypoint, can be determined based on the flight trajectory of the obstacle relative to the UAV at the previous moment, also referred to as a “previous flight trajectory” of the obstacle relative to the UAV. The flight trajectory of the obstacle relative to the UAV at the previous moment can reflect a motion pattern of the obstacle relative to the UAV, and thus, the first predicted waypoint can be determined based on the flight trajectory of the obstacle relative to the UAV at the previous moment. The implementation manner of determining the first predicted waypoint of the obstacle at the current moment according to the flight trajectory of the obstacle relative to the UAV at the previous moment is not limited herein. For example, according to the flight trajectory of the obstacle relative to the UAV at the previous moment, the motion pattern of the obstacle (e.g., a pattern of uniform linear motion, a pattern of uniform acceleration linear motion, or the like) can be determined, and the first predicted waypoint can be determined according to the motion pattern of the obstacle.

In some embodiments, the processes at 301 can further include determining a motion model of the obstacle according to the flight trajectory of the obstacle relative to the UAV at the previous moment, and determining the first predicted waypoint of the obstacle at the current moment according to the motion model. The motion model may represent the first predicted waypoint of the obstacle at the current moment as a function of the waypoint at the previous moment (e.g., a moment immediately before the current moment).

The motion model can be selected according to a motion state of the obstacle and a degree of real-time of the radar. For example, when the motion state of the obstacle is stationary, the motion model may be a constant speed model that can obtain flight speed information of the UAV in real time. One or more of the position of the waypoint, speed, angle, and the like in the flight trajectory of the obstacle relative to the UAV at the previous moment can be used as state variable(s) to determine the motion model of the obstacle. A principle of selecting the state variable(s) from the position of the waypoint, speed, angle, and the like can include selecting a set of variables that has the least number of dimensions and can fully reflect dynamic characteristics of the flight trajectory of the obstacle, thereby preventing an amount of calculation from increasing with the number of state variables. In some embodiments, the state variable(s) can include the speed.

In some embodiments, determining the first predicted waypoint of the obstacle at the current moment according to the motion model may include: determining an estimated waypoint of the obstacle at the current moment according to the motion model, and determining the first predicted waypoint of the obstacle at the current moment using the Kalman algorithm based on the waypoint at the previous moment and the estimated waypoint. For example, the waypoint at the previous moment can be used as a measurement value in the Kalman filter algorithm, and the estimated waypoint can be used as a predicted value in the Kalman filter algorithm, and thus, the estimated value calculated by the Kalman filter algorithm can be the first predicted waypoint.

The implementation manner of determining the first predicted waypoint of the obstacle at the current moment according to the motion model is not limited herein. For example, the estimated waypoint of the obstacle at the current moment determined according to the motion model may be used as the first predicted waypoint. As another example, the first predicted waypoint may be determined by weighting the first estimated waypoint and the waypoint of the flight trajectory at the previous moment (e.g., the moment immediately before the current moment).

At 302, a first correlation wave gate is determined according to the first predicted waypoint. The first correlation wave gate may refer to a space area centered on the first predicted waypoint. The first correlation wave gate may include a rectangular wave gate, a ring wave gate, a circular wave gate, a spherical wave gate, a fan-shaped wave gate, or the like. The following two aspects can be considered when determining a shape and size of the first correlation wave gate: the probability of relevant echoes falling within the first correlation wave gate should be high, and not allowing too many irrelevant echoes to be in the first correlation wave gate. The relevant echoes can be understood to be echoes having corresponding measurement data related to the flight trajectory, and the irrelevant echoes can be understood to be echoes having corresponding measurement data irrelevant to the flight trajectory.

At 303, if the echoes of the radar detected at the current moment fall within the first correlation wave gate, a current waypoint of the flight trajectory is determined according to the measurement data corresponding to the echoes. An echo of the radar detected at the current moment is also referred to as a “current echo” of the radar. Taking a spherical wave gate and a Cartesian coordinate system as an example, a range of the first correlation wave gate may be determined by the following formula (1).

where (x₀, y₀) can represent the coordinate corresponding to the first predicted waypoint in the Cartesian coordinate system, (xₖ, yₖ) can represent the coordinate of the measurement data corresponding to the echo in the Cartesian coordinate system, and K can represent a radius of the spherical wave gate.

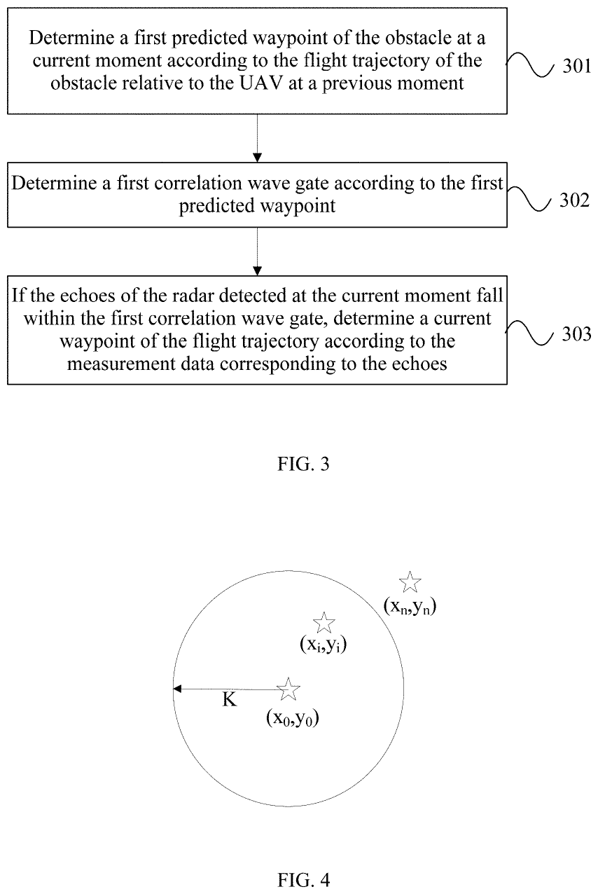

FIG. 4 schematically shows an example relationship between the echoes and the first correlation wave gate consistent with the disclosure. For example, as shown in FIG. 4, the echo corresponding to (xᵢ, yᵢ) falls within the first correlation wave gate, and the echo corresponding to (xₙ, yₙ) does not fall within the first correlation wave gate, i.e., falls outside the first correlation wave gate.

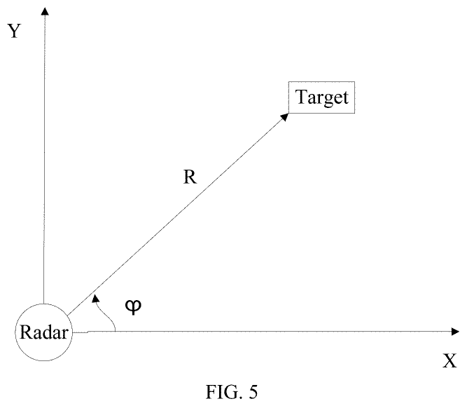

The measurement data output by the radar is generally in the polar coordinate system, and the data processed by the controller is in the Cartesian coordinate system, and hence, the measurement data in the polar coordinate system output by the radar can be converted into the measurement data in the Cartesian coordinate system by using the coordinate system conversion. FIG. 5 schematically shows an example relationship between the radar and obstacles in Cartesian coordinate system consistent with the disclosure. X and Y in FIG. 5 are the two coordinate axes of the Cartesian coordinate system. As shown in FIG. 5, the relationship between a distance R and an azimuth φ of the obstacle and the coordinate x relative to the radar in the Cartesian coordinate system can be as shown in formula (2), and the relationship between R, φ and the coordinate y relative to the radar in the Cartesian coordinate system can be shown in formula (3).

x=R*cos(φ) (2)

y=R*sin(φ) (3)

In some embodiments, when the number of echoes falling in the first correlative wave gate is one, determining the current waypoint of the obstacle according to the measurement data corresponding to the echoes can include: using the measurement data corresponding to the echoes as the current waypoint of the flight trajectory.

In some embodiments, when the number of echoes falling in the first correlative wave gate is more than one, determining the current waypoint of the obstacle according to the measurement data corresponding to the echoes can include: selecting one echo among the multiple echoes, and using the measurement data corresponding to the selected echo as the current waypoint of the flight trajectory. In some embodiments, selecting one echo among the multiple echoes can include selecting the echo among the multiple echoes based on the nearest neighbor method.

For example, an update vector of the ith echo at the k+1 time, vᵢ(k+1), can be determined based on the ith echo at the k+1 time, zᵢ(k+1), using the following formula (4).

vᵢ(k+1)=zᵢ(k+1)−zᵢ(k) (4)

where zᵢ(k) represents the measurement data corresponding to the echo at time k.

The distance gᵢ(k+1) can be determined using the following formula (5) according to vᵢ(k+1).

gᵢ(k+1)=vᵢ^{T}(k+1)S⁻¹(k+1)vᵢ(k+1) (5)

where vᵢ^{T}(k+1) represents a transpose of vᵢ(k+1), and S⁻¹(k+1) represents an innovation covariance matrix.

The echo having a smallest gᵢ (k+1) among the multiple echoes can be selected. The implementation method for selecting the echo among multiple echoes based on the nearest neighbor method is not limited herein. For example, the echo with a closest distance to the echo corresponding to the first predicted waypoint among the multiple echoes.

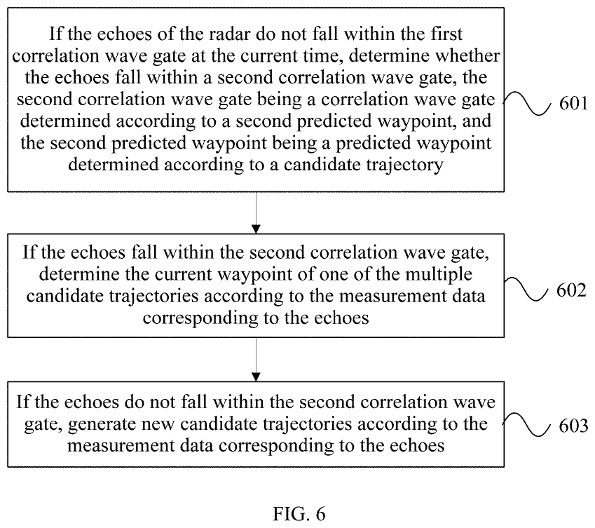

In some embodiments, the obstacle may be not fixed during the flight of the UAV, and thus, in addition to determining the flight trajectory described above, a new flight trajectory different from the flight trajectory described above can be determined. Therefore, when the echo of the radar does not fall within the first correlative wave gate at the current moment, the new flight trajectory may be determined according to the measurement data. The processing method for determining the new flight trajectory according to the measurement data may be similar to the processing method for generating a candidate trajectory in the method shown in FIG. 6, and detailed description thereof is omitted herein.

Consistent with the disclosure, the first predicted waypoint of the obstacle at the current moment can be determined by the flight trajectory of the obstacle relative to the UAV at the previous moment. According to the first predicted waypoint, the first correlation wave gate can be determined. If the echoes of the radar fall within the first correlation wave gate at the current moment, the current waypoint of the flight trajectory can be determined according to the measurement data corresponding to the echoes. Based on the measurement data output by the radar, the flight trajectory of the obstacle relative to the UAV can be determined.

FIG. 6 is a schematic flow chart of another example obstacle avoidance method for UAV consistent with the disclosure. Based on the method in FIG. 3, the method in FIG. 6 provides an example implementation manner of determining the flight trajectory of the obstacle relative to the UAV, when the echoes of the radar do not fall within the first correlation wave gate at the current moment. As shown in FIG. 6, at 601, if the echoes of the radar do not fall within the first correlation wave gate at the current moment, whether the echoes fall within a second correlation wave gate is determined. The second correlation wave gate can be a correlation wave gate determined according to a second predicted waypoint. The second predicted waypoint can be a predicted waypoint determined according to a candidate trajectory.

During the flight of the UAV, the obstacle may be not fixed. In order to improve an accuracy of the flight trajectory of the obstacle, in addition to the flight trajectory described above, multiple candidate trajectories that may become the flight trajectory of the obstacle can also be determined. When the echoes of the radar do not fall within the first correlation wave gate at the current moment, it may be further determined whether the echoes fall within the second correlation wave gate determined based on the candidate trajectories. The number of the candidate flight trajectories may be one or more, which is not limited herein. The second correlation wave gate is similar to the first correlation wave gate described above, and detailed description thereof is omitted herein.

At 602, if the echoes fall within the second correlation wave gate, the current waypoint of one of the multiple candidate trajectories is determined according to the measurement data corresponding to the echoes. The processes at 602 is similar to the processes at 303, and detailed description thereof is omitted herein.

At 603, if the echoes do not fall within the second correlation wave gate, new candidate trajectories are generated according to the measurement data corresponding to the echoes. During the flight of the UAV, the obstacle may be not fixed. Therefore, in addition to the flight trajectory and candidate trajectories described above, the new candidate trajectories different from the flight trajectory and candidate trajectories described above can also be determined. In some embodiments, generating the trajectories needs to consider establishing trajectories for the obstacle as soon as possible and avoiding false trajectories as far as possible.

In some embodiments, each of the new candidate trajectories can be generated as follows. When the number of second measurement data in first measurement data output by the radar at M consecutive times is greater than or equal to K, the candidate trajectories can be generated. The second measurement data can include the first measurement data whose degree of difference with the measurement data immediately before the first measurement data is less than or equal to a preset difference degree. The candidate trajectory can include waypoint information determined according to each first measurement data. M is a positive integer greater than or equal to 2, and K is a positive integer less than or equal to M.

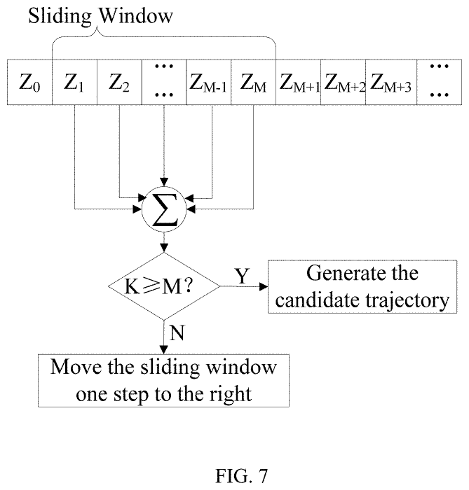

Assume that when the difference between the first measurement data at the ith moment and the measurement data at the previous moment (i−1)th is less than or equal to the preset difference degree, Zᵢ equals 1. When the difference between the first measurement data at the ith moment and the measurement data at the previous moment (i−1)th is greater than the preset difference degree, Zᵢ equals 0. FIG. 7 schematically shows generating an example candidate trajectory consistent with the disclosure. As shown in FIG. 7, whether a sum of M consecutive Zᵢ (e.g., from Z₀ to Z_{M-1}), K, is greater than or equal to M, i.e., whether Z₀ to Z_{M-1} can be considered to be located in a sliding window, can be first determined. When K is greater than or equal to M, the candidate trajectory can be generated. When K is less than M, it is further determined whether the sum of M consecutive Zᵢ (e.g., from Zₐ to Z_{M}), K, is greater than or equal to M, i.e., the sliding window is moved one step to the right. When K is greater than or equal to M, the candidate trajectory can be generated, and when K is less than M, it is further determined whether the sum of M consecutive Zᵢ (from Z₂ to Z_{M+1}), K, is greater than or equal to M, and so on. Z₀ can be equal to 1 or 0 by default.

During the flight of the UAV, the obstacle may be not fixed. In order to determine the accuracy of the trajectory (e.g., the flight trajectory and the candidate trajectory of the obstacle), a quality of the trajectory can be managed. A higher quality of the trajectory corresponds to a higher accuracy of the trajectory, and a lower quality of the trajectory corresponds to a lower accuracy of the trajectory.

In some embodiments, the quality of the trajectory can be managed as follows. According to the degree of difference between the current waypoint and the first predicted waypoint, the quality of the flight trajectory can be updated. According to the degree of difference between the current waypoint and the second predicted waypoint, the quality of the candidate trajectory can be updated. A smaller degree of difference corresponds to a better quality of the trajectory, and a greater degree of difference corresponds to a worse quality of the trajectory. The current waypoint may be the current waypoint of the candidate trajectory or the flight trajectory described above.

During the flight of the UAV, the candidate trajectory described above may become the flight trajectory of the obstacle, or may not become the flight trajectory of the obstacle. The flight trajectory may also become the candidate trajectory after a period of time. In some embodiments, on the basis of managing the quality of the trajectory, the trajectory can be further managed according to the quality of the trajectory. For example, the candidate trajectory and the flight trajectory can be managed according to the quality of the trajectory.

In some embodiments, managing the candidate trajectory and the flight trajectory according to the quality of the trajectory can include: when the quality of the flight trajectory is less than or equal to a first preset trajectory quality, using the flight trajectory as the candidate trajectory, and when the quality of the candidate trajectory is greater than or equal to a second preset trajectory quality, using the candidate trajectory as the flight trajectory. The first preset trajectory quality and the second preset trajectory quality can be flexibly designed according to actual needs, which are not limited herein.

In some embodiments, in order to reduce the number of trajectories to be managed, the trajectory can also be deleted. Herein, “delete” can be understood as an operation opposite to the operation “generate” described above. Managing the candidate trajectory and the flight trajectory according to the quality of the trajectory may further include: when the quality of the candidate trajectory is less than or equal to a third preset trajectory quality, deleting the candidate trajectory. The third preset trajectory quality can be less than the first preset trajectory quality.

In some embodiments, if the echoes of the radar do not fall within the first correlation wave gate at the current moment, whether the echoes fall within the second correlation wave gate can be determined. If the echoes fall within the second correlation wave gate, the current waypoint of the candidate trajectory can be determined based on the measurement data corresponding to the echoes. If the echoes do not fall within the second correlation wave gate, the new candidate trajectory can be generated based on the measurement data corresponding to the echoes. On the basis of the flight trajectory of the obstacle, the generation and update of the candidate trajectory can be realized, and the accuracy of the flight trajectory of the obstacle can be improved.

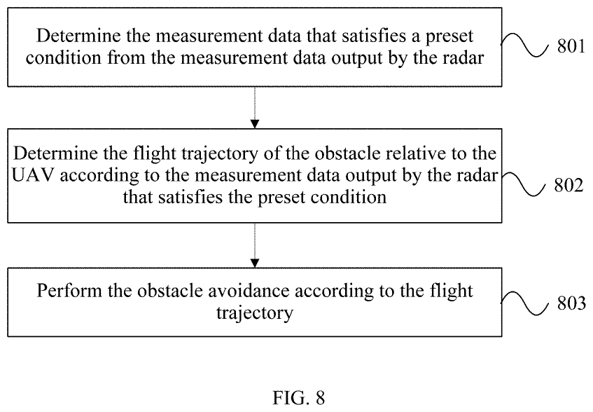

FIG. 8 is a schematic flow chart of another example obstacle avoidance method for UAV consistent with the disclosure. The method in FIG. 8 describes an example implementation manner of obstacle avoidance using data from the measurement data output by the radar.

As shown in FIG. 8, at 801, the measurement data that satisfies a preset condition is determined from the measurement data output by the radar. Radar generally has a large detection range, and a range that the UAV needs to detect the obstacles can be only part of the detection range. Therefore, the measurement data related to the obstacle avoidance can be determined from the measurement data output by the radar according to the preset condition. The measurement data that satisfies the preset condition in the measurement data output by the radar can be regarded as reliable data that can be used, and the measurement data that does not satisfy the preset condition in the measurement data output by the radar can be considered as useless data that cannot be used. In some embodiments, the preset condition can include a distance threshold condition and/or an angle threshold condition. The distance threshold condition may be defined by one or more preset distances. For example, when defined by one preset distance, the distance threshold condition may be greater than or equal to the preset distance, or less than or equal to the preset distance. When defined by two preset distances (e.g., preset distance 1 and preset distance 2), the distance threshold condition may be greater than or equal to preset distance 1 and less than or equal to preset distance 2. The angle threshold condition may be defined by one or more preset angles. For example, when defined by one preset angle, the angle threshold condition may be greater than or equal to the preset angle, or less than or equal to the preset angle. When defined by two preset angles (e.g., preset angle 1 and preset angle 2), the angle threshold condition may be greater than or equal to preset angle 1 and less than or equal to preset angle 2.

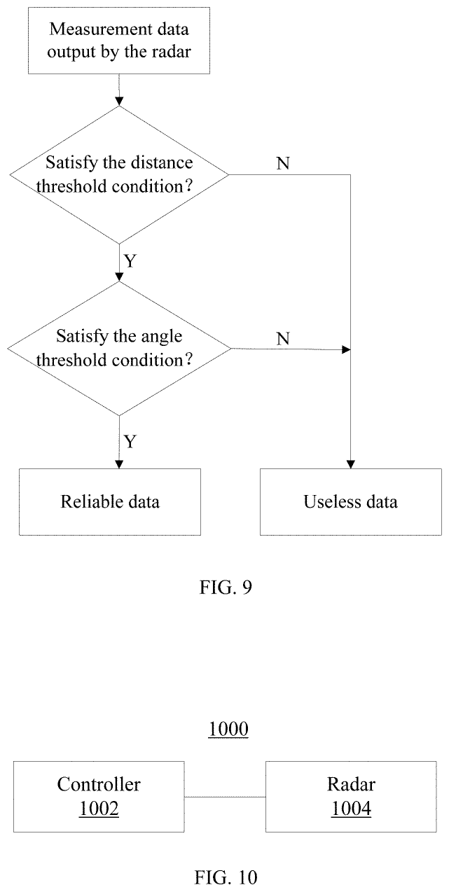

FIG. 9 schematically shows determining the measurement data satisfying the preset condition consistent with the disclosure. When the preset condition includes both the distance threshold condition and the angle threshold condition, the processes at 801 can be executed as shown in FIG. 9. For example, as shown in FIG. 9, whether the measurement data output by the radar satisfies the distance threshold condition is determined. If the measurement data output by the radar does not satisfy the distance threshold condition, the measurement data is determined as the useless data. If the measurement data output by the radar satisfies the distance threshold condition, whether the measurement data output by the radar satisfies the angle threshold condition is determined. If the measurement data output by the radar does not satisfy the angle threshold condition, the measurement data is determined as the useless data. If the measurement data output by the radar satisfies the angle threshold condition, the measurement data is determined as the reliable data. As another example, whether the measurement data output by the radar satisfies the angle threshold condition can be determined. If the measurement data output by the radar does not satisfy the angle threshold condition, the measurement data can be determined as the useless data. If the measurement data output by the radar satisfies the angle threshold condition, whether the measurement data output by the radar satisfies the distance threshold condition can be determined. If the measurement data output by the radar does not satisfy the distance threshold condition, the measurement data can be determined as the useless data. If the measurement data output by the radar satisfies the distance threshold condition, the measurement data can be determined as the reliable data.

Referring again to FIG. 8, at 802, the flight trajectory of the obstacle relative to the UAV is determined according to the measurement data output by the radar that satisfies the preset condition. For the method for determining the flight trajectory of the obstacle relative to the UAV according to the measurement data is similar as the methods in FIGS. 1, 3 and 6, and detail description thereof is omitted herein.

At 803, the obstacle avoidance is performed according to the flight trajectory. The processes at 803 are similar to the processes at 102, and detailed description thereof is omitted herein.

Consistent with the disclosure, the measurement data that satisfies the preset condition in the measurement data output by the radar can be determined. According to the measurement data output by the radar that satisfies the preset condition, the flight trajectory of the obstacle relative to the UAV can be determined. The amount of data calculation can be reduced, thereby reducing a burden on the controller and increasing a processing speed. The possibility of false trajectory formation can be reduced.

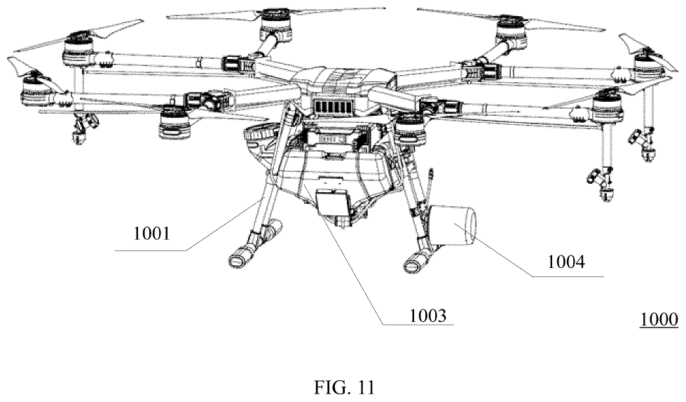

FIG. 10 is a schematic structural diagram of an example UAV 1000 consistent with the disclosure. FIG. 11 schematically shows a physical structural diagram of the UAV 1000 consistent with the disclosure. As shown in FIGS. 10 and 11, the UAV 1000 includes a rack 1001, a controller 1002 arranged at the rack 1001, and a radar 1004 arranged at the rack 1001 or at a load 1003 of the rack 1001. The radar 1004 can be configured to obtain the measurement data. The controller 1002 can communicate with the radar 1004, and configured to determine the flight trajectory of the obstacle relative to the UAV 1000 according to the measurement data output by the radar 1004, and perform the obstacle avoidance according to the flight trajectory.

In some embodiments, the controller 1002 determining the flight trajectory of the obstacle relative to the UAV 1000 according to the measurement data output by the radar 1004 can include the following processes. The first predicted waypoint of the obstacle at the current moment is determined according to the flight trajectory of the obstacle relative to the UAV at the previous moment. The first correlation wave gate is determined according to the first predicted waypoint. If the echoes of the radar fall within the first correlation wave gate at the current moment, the current waypoint of the flight trajectory is determined according to the measurement data corresponding to the echoes.

In some embodiments, when the number of echoes falling in the first correlative wave gate is one, the controller 1002 determining the current waypoint of the obstacle according to the measurement data corresponding to the echoes can include: using the measurement data corresponding to the echoes as the current waypoint of the flight trajectory.

In some embodiments, when the number of echoes falling in the first correlative wave gate is more than one, the controller 1002 determining the current waypoint of the obstacle according to the measurement data corresponding to the echoes can include: selecting one echo among the multiple echoes, and using the measurement data corresponding to the selected echo as the current waypoint of the flight trajectory. In some embodiments, the controller 1002 selecting one echo among the multiple echoes can include selecting the echo among the multiple echoes based on the nearest neighbor method.

In some embodiments, the controller 1002 can be further configured to determine whether the echoes fall within a second correlation wave gate in response to the echoes of the radar not falling within the first correlation wave gate at the current moment, determine the current waypoint of one of the multiple candidate trajectories according to the measurement data corresponding to the echoes in response to the echoes falling within the second correlation wave gate, and generate the new candidate trajectories according to the measurement data corresponding to the echoes in response to the echoes not falling within the second correlation wave gate. The second correlation wave gate can refer to the correlation wave gate determined according to the second predicted waypoint. The second predicted waypoint can refer to a predicted waypoint determined according to the candidate trajectory.

In some embodiments, the controller 1002 generating the new candidate trajectories according to the measurement data corresponding to the echoes can include the following processes. When the number of second measurement data in first measurement data output by the radar at M consecutive times is greater than or equal to K, the candidate trajectories can be generated. The second measurement data can include the first measurement data whose degree of difference with the measurement data immediately before the first measurement data is less than or equal to the preset difference degree. The candidate trajectory can include waypoint information determined according to each first measurement data. M is a positive integer greater than or equal to 2, and K is a positive integer less than or equal to M.

In some embodiments, the controller 1002 can be further configured to update the quality of the flight trajectory according to the degree of difference between the current waypoint and the first predicted waypoint, and update the quality of the candidate trajectory according to the degree of difference between the current waypoint and the second predicted waypoint. A smaller degree of difference corresponds to a better quality of the trajectory, and a greater degree of difference corresponds to a worse quality of the trajectory.

In some embodiments, the controller 1002 can be further configured to manage the candidate trajectory and the flight trajectory according to the quality of the trajectory. In some embodiments, the controller 1002 managing the candidate trajectory and the flight trajectory according to the quality of the trajectory can include: when the quality of the flight trajectory is less than or equal to the first preset trajectory quality, using the flight trajectory as the candidate trajectory, and when the quality of the candidate trajectory is greater than or equal to the second preset trajectory quality, using the candidate trajectory as the flight trajectory.

In some embodiments, the controller 1002 managing the candidate trajectory and the flight trajectory according to the quality of the trajectory can further include: when the quality of the candidate trajectory is less than or equal to the third preset trajectory quality, deleting the candidate trajectory. The third preset trajectory quality can be less than the first preset trajectory quality.

In some embodiments, the controller 1002 determining the first predicted waypoint of the obstacle at the current moment according to the flight trajectory of the obstacle relative to the UAV at the previous moment can include: determining the motion model of the obstacle according to the flight trajectory of the obstacle relative to the UAV at the previous moment, and determining the first predicted waypoint of the obstacle at the current moment according to the motion model.

In some embodiments, the controller 1002 determining the first predicted waypoint of the obstacle at the current moment according to the motion model can include: determining the estimated waypoint of the obstacle at the current moment according to the motion model, and determining the first predicted waypoint of the obstacle at the current moment using the Kalman algorithm based on the waypoint at the previous moment and the estimated waypoint.

In some embodiments, the controller 1002 can be further configured to determine the measurement data that satisfies the preset condition from the measurement data output by the radar before using the measurement data output by the radar. The controller 1002 determining the flight trajectory of the obstacle relative to the UAV according to the measurement data output by the radar can include: determining the flight trajectory of the obstacle relative to the UAV according to the measurement data output by the radar that satisfies the preset condition.

In some embodiments, the preset condition can include the distance threshold condition and/or the angle threshold condition. In some embodiments, the controller 1002 performing the obstacle avoidance according to the flight trajectory can include controlling the flight attitude of the UAV according to the flight trajectory of the obstacle relative to the UAV to perform the obstacle avoidance.

In some embodiments, the controller 1002 can be further configured to control the radar 1004 to continuously rotate, and obtain the measurement data of the radar 1004 during continuous rotation. In some embodiments, when the radar 1004 is continuously rotating, the radar 1004 can emit the radar waves toward the front direction, the lower front direction, the downward direction, the back direction, the lower back direction, and the upward direction of the UAV 1000. In some embodiments, the direction of the rotation axis of the radar 1004 may be parallel to the pitch axis of the UAV 1000. The UAV 100 can include a multi-rotor UAV, for example, a four-rotor UAV.

FIG. 11 takes the radar 1004 having the rotating antenna as an example, and an installation position of the radar 1004 on the UAV 1000 is merely an example. FIG. 11 is merely a schematic diagram illustrating an example physical structure of the UAV 1000, and not intended to limit the structure of the UAV 1000.

The controller 1002 of the UAV 1000 can be configured to execute the methods in FIGS. 1, 3, 6, and 8. The implementation principle and technical effect are similar to the methods in FIGS. 1, 3, 6, and 8, and detailed description thereof is omitted herein.

Some or all of the processes of the method described above can be executed by hardware running program instructions. The program may be stored in a computer-readable storage medium. When the program is executed, the processes of the method are executed. The computer-readable storage medium can include a read-only memory (ROM), a random-access memory (RAM), a magnetic disk, an optical disk, or another medium that can store program codes.

It is intended that the disclosed embodiments be considered as exemplary only and not to limit the scope of the disclosure. Changes, modifications, alterations, and variations of the above-described embodiments may be made by those skilled in the art within the scope of the disclosure.

What is claimed is:

1. An obstacle avoidance method for an unmanned aerial vehicle (UAV) comprising:
determining a flight trajectory of an obstacle relative to the UAV according to measurement data output by a radar arranged at the UAV; and
performing an obstacle avoidance according to the flight trajectory of the obstacle.

2. The method of claim 1, wherein determining the flight trajectory of the obstacle relative to the UAV includes:
determining a predicted waypoint of the obstacle at a current moment according to a previous flight trajectory of the obstacle relative to the UAV at a previous moment;
determining a correlation wave gate according to the predicted waypoint;
determining whether one or more current echoes of the radar detected at the current moment fall within the correlation wave gate; and
in response to the one or more current echoes falling within the correlation wave gate, determining a current waypoint of the flight trajectory according to the measurement data corresponding to the one or more current echoes.

3. The method of claim 2, wherein:
the one or more current echoes falling within the correlation wave gate include one current echo falling within the correlation wave gate; and
determining the current waypoint of the flight trajectory includes determining the measurement data corresponding to the one current echo as the current waypoint of the flight trajectory.

4. The method of claim 2, wherein:
the one or more current echoes falling within the correlation wave gate include a plurality of current echoes falling within the correlation wave gate; and
determining the current waypoint of the flight trajectory includes:
selecting one current echo from the plurality of current echoes; and
determining the measurement data corresponding to the selected current echo as the current waypoint of the flight trajectory.

5. The method of claim 4, wherein selecting the one current echo from the plurality of current echoes includes selecting the one current echo based on a nearest neighbor method.

6. The method of claim 2,
wherein the correlation wave gate is a first correlation wave gate and the predicted waypoint is a first predicted waypoint;
the method further comprising:
in response to the one or more current echoes not falling within the first correlation wave gate, determining whether the one or more current echoes fall within a second correlation wave gate determined according to a second predicted waypoint, the second predicted waypoint being determined according to a candidate trajectory;
in response to the one or more current echoes falling within the second correlation wave gate, determining a current waypoint of the candidate trajectory according to the measurement data corresponding to the one or more current echoes; and
in response to the one or more current echoes not falling within the second correlation wave gate, generating a new candidate trajectory according to the measurement data corresponding to the one or more current echoes.

7. The method of claim 6, wherein:
generating the new candidate trajectory includes:
obtaining M measurement data points output by the radar at M consecutive times, M being a positive integer greater than or equal to 2; and
generating the new candidate trajectory in response to determining that at least K out of the M measurement data points each differ from an immediately preceding measurement data point by a difference less than or equal to a preset difference, K being a positive integer less than or equal to M; and
the new candidate trajectory includes waypoint information determined according to the measurement data points.

8. The method of claim 6, further comprising:
updating a quality of the flight trajectory according to a difference between the current waypoint and the first predicted waypoint; and
updating a quality of the candidate trajectory according to a difference between the current waypoint and the second predicted waypoint.

9. The method of claim 8, further comprising:
managing the candidate trajectory and the flight trajectory according to the quality of the candidate trajectory and the quality of the flight trajectory.

10. The method of claim 9, wherein managing the candidate trajectory and the flight trajectory includes performing at least one of:
using the flight trajectory as the candidate trajectory in response to the quality of the flight trajectory being less than or equal to a first preset trajectory quality; or
using the candidate trajectory as the flight trajectory in response to the quality of the candidate trajectory being greater than or equal to a second preset trajectory quality.

11. The method of claim 10, wherein managing the candidate trajectory and the flight trajectory further includes:
deleting the candidate trajectory in response to the quality of the candidate trajectory being less than or equal to a third preset trajectory quality, the third preset trajectory quality being less than the first preset trajectory quality.

12. The method of claim 2, wherein determining the predicted waypoint of the obstacle at the current moment includes:
determining a motion model of the obstacle according to the previous flight trajectory of the obstacle; and
determining the predicted waypoint of the obstacle at the current moment according to the motion model.

13. The method of claim 12, wherein determining the predicted waypoint of the obstacle at the current moment according to the motion model includes:
determining an estimated waypoint of the obstacle at the current moment according to the motion model; and
determining the predicted waypoint of the obstacle at the current moment using a Kalman algorithm based on a waypoint at the previous moment and the estimated waypoint.

14. The method of claim 1, further comprising:
determining the measurement data that satisfies a preset condition from candidate measurement data output by the radar before determining the flight trajectory of the obstacle relative to the UAV;
wherein determining the flight trajectory of the obstacle relative to the UAV includes determining the flight trajectory of the obstacle relative to the UAV according to the measurement data output by the radar that satisfies the preset condition.

15. The method of claim 14, wherein the preset condition includes at least one of a distance threshold condition or an angle threshold condition.

16. The method of claim 1, wherein performing the obstacle avoidance according to the flight trajectory includes controlling a flight attitude of the UAV according to the flight trajectory of the obstacle relative to the UAV to perform the obstacle avoidance.

17. The method of claim 1, further comprising:
controlling the radar to continuously rotate; and
obtaining the measurement data of the radar during continuous rotation.

18. The method of claim 17, further comprising:
controlling the radar to emit radar waves toward at least one of a front direction, a lower front direction, a downward direction, a back direction, a lower back direction, or an upward direction of the UAV during the continuous rotation.

19. The method of claim 1, wherein a rotation axis of the radar is parallel to a pitch axis of the UAV.

20. An unmanned aerial vehicle (UAV) comprising:
a rack;
a radar arranged at the rack or at a load carried by the rack, and configured to obtain measurement data; and
a controller arranged at the rack and communicatively coupled to the radar, and configured to:
determine a flight trajectory of an obstacle relative to the UAV according to the measurement data output by the radar; and
perform an obstacle avoidance according to the flight trajectory of the obstacle.
